(19) United States
(12) Patent Application Publication
(10) Pub. No.: US 2003/0148092 A1
(43) Pub. Date: Aug. 7, 2003

(54) Brushable paint and method of coating a wall of a structure

(76) Inventor: Nicole Gross, Oberhausen (DE)

Correspondence Address: THE FIRM OF KARL F ROSS, 5676 RIVERDALE AVENUE, PO BOX 900, RIVERDALE (BRONX), NY, 10471-0900, US

(21) Appl. No.: 10/242,317

(22) Filed: Sep. 12, 2002

(30) Foreign Application Priority Data
Feb. 1, 2002 (EP) 02002414.7

(51) Int. Cl. B32B 18/00

(52) U.S. Cl. 428/325; 428/332

(57) ABSTRACT

A brushable paint for interior and/or exterior and/or roof coatings in which the paint contains at least one acrylate and water and is usually organic solvent-free and contains 2 to 20 weight % of hollow glass beads.

### FIELD OF THE INVENTION

The present invention relates to a brushable paint and to a method of painting a wall of a structure or, stated differently, a method of improving the property of a wall of a structure. The invention also relates specifically to paints which can be used as interior, exterior and roof paint.

### BACKGROUND OF THE INVENTION

Brushable paints, i.e. paints which have viscosity and flowability properties which enable them to be brushed onto a surface and to form substantially continuous coatings when applied by brushing to the surface, are known in a variety of types. As a general matter, however, such paints are not fully satisfactory in the sense that they do not satisfy all of the requirements for such paints in many applications. For example, when a paint is applied to an exterior wall, the paint usually does not contribute to a reduction in heat loss from the interior to protection of the interior from the incursion of cold. Conversely, known paints utilized for interior wall covering have little effect on penetration of heat from the exterior into the interior, for example, in the summer time and do not contribute to protection of the interior from the heating effects of the exterior. In fact, in many cases conventional paints contribute to heat transfer through the wall and can give rise to nonuniform temperature distributions in the interior of the building.

Furthermore, conventional paints tend to crack with time and the resulting cracks can be relatively deep and unsightly and contribute to weathering of the surface to which the paint is applied. Conventional paints may also not be fully satisfactory with respect to coverage of the surface.

### OBJECTS OF THE INVENTION

It is, therefore, the principal object of the present invention to provide an improved paint which can be easily applied by brushing and which will avoid the disadvantages enumerated previously.

More specifically, it is an object of the invention to provide a paint with improved durability and resistance to cracking, which is more capable of adequately covering an interior, exterior or roof surface than earlier paints and which will increase the protection of interior spaces to loss of heating or the incursion of heat.

Another object of the invention is to provide an improved method of painting an exterior wall of a building.

It is also an object of the invention to provide an improved exterior wall structure.

### SUMMARY OF THE INVENTION

These objects can be achieved, according to the invention, by an improved brushable paint for interior, exterior and roof applications which comprises a substantially organic solvent-free acrylate and water composition containing hollow glass beads in an amount of 2 to 20 weight percent of the paint and dispersed therein.

The paint, therefore, comprises at least one acrylate and water and otherwise is substantially solvent-free but includes 2 to 20 weight percent (of the paint) of hollow glass beads, i.e. microspheres of glass.

Interior and exterior application means that the paint can be applied to internal surfaces or external surfaces of buildings and roof applications signify that the exterior application of the paint can include application of the paint to the roof.

When reference is made to a solvent-free state of the paint, I mean that the paint should contain either no organic solvents or organic solvents only in a negligible amount. Solvent-free, therefore, can mean within the scope of the present disclosure that the organic solvent content in the paint is less than 1% by weight and preferably less than 0.5% by weight. The hollow glass beads are beads whose walls are composed of glass and preferably enclose a vacuum.

According to a feature of the invention, the brushable paint contains an aqueous acrylate dispersion. The pH value of the paint can advantageously be 8.5 to 9.5, more preferably 8.7 to 9.3 and best in the range of 8.8 to 9.2.

When weight percents are given here, it will be understood that those weight percents are of the complete paint or paint composition and thus of the flowable brush-applicable paint. The brush-applicable paint can contain additional fillers, if desired, preferably titanium dioxide and/or carbonates, especially calcium carbonate. In the preferred compositions of the invention, the paint contains 15 to 25% by weight of these further fillers.

In a preferred embodiment of the invention the brushable paint contains 30 to 60% by weight, preferably 35 to 55% by weight and best 37 to 55% by weight of an acrylate which can be a methacrylate. In a highly preferred embodiment of the paint, 38 to 54 weight % of the acrylate is present. It has been noted that the paint should contain 2 to 20 weight % hollow glass beads and in a preferred range the hollow glass beads are present in an amount of 2 to 18 weight %.

The paints of the invention have significant advantages by comparison with prior art paints and, for example, one may mention the crack-bridging characteristics of the paint, whereby any incipient crack formation is greatly limited by the bridging capability of the paint. Known paints tend to crack and peel after relatively short periods and such cracking and peeling is not a characteristic of the paints of the invention. In fact deep cracks, surprisingly, do not arise.

Furthermore, the paints of the invention are characterized by excellent adhesion to prepared surfaces, e.g. standard primed surfaces, and the paints have high color stability and brilliance.

The paints are also surprisingly effective in limiting the spread or penetration of fire and, on the one hand, the paint is not highly flammable but rather impedes combustion and can be self-extinguishing. The glass beads appear to provide a thermal barrier which limits heat transfer and the spread or transmission of fire.

It has been found that there are particular compositions within the generic description of the paint according to the invention which are particularly useful for interior paints, exterior paints and roof paints.

According to the invention, an interior paint can contain 4 to 17% by weight, preferably 8 to 17% by weight and most preferably 11.5 to 17% by weight of the hollow glass beads or microspheres. The interior paint is particularly useful for painting the inner side of an exterior wall of a building. The viscosity of the paint for interior walls for a shear gradient of 5 sec⁻¹ is preferably 8 to 11 mPas and preferably 9 to 10.6 mPas. The interior paint advantageously has the following composition: 38 to 53 weight %, preferably 40 to 51 weight % of the acrylate component, 18 to 26 weight %, preferably 20 to 24 weight % water, 12 to 15 weight % of the hollow glass beads. With the latter content of hollow glass beads, the preferred quality component can make up 40 to 44 weight % and the water 21 to 25 weight % of the composition. The interior paint can have more than 12 weight % and preferably more than 12.5 weight % of the hollow glass beads. The interior paint is applied in a thickness of 0.15 to 0.5 mm, preferably 0.2 to 0.35 mm and still more preferably 0.25 to 0.3 mm. The layer thickness is measured for the hardened paint layer.

The interior paint of this invention has the advantage that it ensures rapid and uniform distribution of heat in a room bounded by the wall provided with the paint layer. This room appears to have a reduced air circulation and thus reduced dust migration and entrainment so that the air quality in the room is significantly improved. In addition, the interior paint has been found to improve the air-conditioning within the room.

Indeed, when an exterior wall is coated on its interior side with the interior paint of the invention and on the exterior side with the exterior paint, a surprising uniformity of the heat distribution can be measured in the room and the air-conditioning therein is found to be significantly more effective than heretofore. The temperature distribution is surprisingly uniform over the interior wall and especially over the entire height of the wall and the room. The paint inhibits mold development and is both dust and nicotine repellent. The paint is highly workable and thus easily applied to the interior wall surface.

The exterior wall paint of the invention can contain 2 to 10% by weight, preferably 2 to 9% by weight and more preferably 3 to 8% by weight of the hollow glass beads or microspheres. The acrylate proportion in the exterior wall paint can be 43 to 55 weight %, preferably 44 to 53 weight % and more preferably 45 to 52 weight %. The water content of the exterior paint should be 18 to 26 weight %, preferably 20 to 24 weight %.

In one preferred embodiment, the exterior paint contains 2 to 6 weight % of the hollow glass beads, 47 to 51 weight % of the acrylate component and 20 to 24% water. The exterior paint is applied in a layer thickness of 0.15 to 0.5 mm, preferably 0.2 to 0.35 mm and more preferably 0.25 to 0.3 mm, measured in terms of the hardened paint layer.

The exterior paint has been found to effectively absorb solar radiation even at low exterior temperatures and above all in winter time. Because of the resulting solar energy capture, the interior heating requirements can be reduced. At high exterior temperatures, especially in the summer time, the reflective characteristics of the exterior paint prevents overheating of interior spaces and thus reduces the cooling requirements for air-conditioning. The exterior paint is also surprisingly resistant to ultraviolet and weather resistant. It is also resistant to fungal, moss and algae growth and adhesion. The exterior paint is also surprisingly resistant to aggressive environmental effects.

The roof paint of the invention contains 2 to 12% by weight, preferably 2 to 8% by weight hollow glass beads as described previously. The roof paint is applied in a layer thickness of 0.3 to 1.5 mm, preferably 0.5 to 1 mm as measured in the hardened state of the paint layer.

The roof paint according to the invention can contain 42 to 55 weight %, preferably 43 to 53 weight % and more preferably 45 to 53 weight % of the acrylate component. The water content in the roof paint can be 19 to 24 weight %, preferably 20 to 24 weight %. In a preferred embodiment the roof paint contains 2 to 7 weight % of the hollow glass beads, 48 to 52 weight % of the acrylate and 21 to 24 weight % water.

The roof paint of the invention also has special advantages. The roof paint is surprisingly effective as a reflector and thus, especially in the summer on the hottest days, where there are high exterior temperatures, will be reflective of solar radiation and thus prevent excessive heating of the space below the roof and the interior of the building. The high UV resistance and weather resistance of the paint is also of special advantage in the case of the roof paint. The development of moss and fungus on the roof is effectively limited and the resistance to aging is especially surprising.

The glass beads which are used preferably have a vacuum inside them and the wall thicknesses of the glass beads should be 0.3 to 5 μm, preferably 0.5 to 3.5 μm and most preferably 0.5 to 3 μm. The glass beads can have diameters of 2 to 150 μm and most preferably between 10 and 140 μm. At least 50 volume % of the hollow glass beads should have a diameter between 10 and 70 μm, preferably between 20 and 70 μm. The hollow glass beads are preferably composed of sodium lime-borosilicate glass. In a preferred embodiment the density of the hollow glass beads is 0.2 to 3 g/cm³, preferably 0.22 to 0.28 g/cm³, and most preferably 0.25 g/cm³. The density is here the average particle density.

In the paint according to the invention the hollow glass microspheres are embedded in a polymer matrix formed by the drying acrylate/water suspension. The hollow glass beads are homogeneously distributed in this matrix and the resulting composite provides the advantageous results upon coating the interior or exterior surfaces and especially the results with respect to adhesion and crack-bridging.

### BRIEF DESCRIPTION OF THE DRAWING

The above and other objects, features, and advantages will become more readily apparent from the following description, reference being made to the accompanying drawing in which:

FIG. 1 is a cross sectional view in perspective through an exterior wall of a building according to the invention; and

FIG. 2 is a cross sectional view through a portion of a wall provided with the paint of the invention.

### SPECIFIC DESCRIPTION

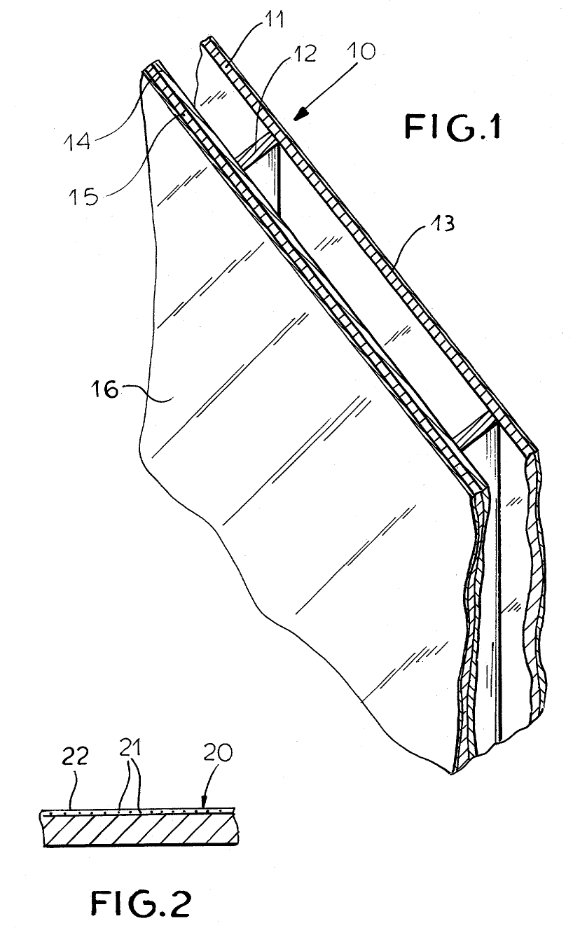

In FIG. 1 I have shown an exterior wall 10 of a building which has on the inner side, a plasterboard or other interior surface-forming member 11 supported by studs 12 and provided with the interior paint coating 13 which has been brushed on and dried to a layer thickness of 0.15 to 0.6 mm. The usual insolation within this exterior wall has not been shown. The portion of the wall turned toward the outside has an inner plywood layer 14, an exterior sheathing 15 and an exterior paint coating, according to the invention as represented at 16, also brushed on and dried to a thickness of 0.15 to 0.6 mm.

In the enlarged view of FIG. 2, the paint layer 20 is shown to contain the glass beads or microspheres 21 embedded in the matrix formed by the dried acrylate dispersion at 22. The wall having paint according to the invention on both its exterior and interior surfaces serves as a moisture barrier preventing incursion of moisture and has been found to greatly reduce the energy requirement for heating interior spaces in the winter and air-conditioning them in the summer. Heat loss through the wall is significantly reduced in the winter time and solar heat incursion is significantly limited by the reflective nature of the exterior coating.

I claim:

1. A brush-applicable interior and exterior paint comprising:
a substantially organic solvent free acrylate and water composition containing hollow glass beads in an amount of 2 to 20 weight percent of the paint and dispersed therein.

2. The paint defined in claim 1 formulated as an interior paint and which contains hollow glass beads in an amount of 4 to 17 weight percent of the paint.

3. The paint defined in claim 2 which contains hollow glass beads in an amount of hollow glass beads in an amount of 11.5 to 17 weight percent of the paint.

4. The paint defined in claim 1 formulated as an exterior paint and which contains hollow glass beads in an amount of 2 to 10 weight percent of the paint.

5. The paint defined in claim 4 which contains hollow glass beads in an amount of 3 to 8 weight percent of the paint.

6. The paint defined in claim 1 formulated as a roof paint and which contains hollow glass beads in an amount of 2 to 12 weight percent of the paint.

7. The paint defined in claim 6 which contains hollow glass beads in an amount of 2 to 8 weight percent of the paint.

8. The paint defined in claim 1 wherein at least 50 percent by volume of the hollow glass beads have diameters between 20 and 70 μm.

9. The paint defined in claim 8 wherein said hollow glass beads have a density of 0.2 to 0.3 g/cm³.

10. The paint defined in claim 9 formulated as an interior paint and which contains hollow glass beads in an amount of 4 to 17 weight percent of the paint.

11. The paint defined in claim 10 which contains hollow glass beads in an amount of hollow glass beads in an amount of 11.5 to 17 weight percent of the paint.

12. The paint defined in claim 9 formulated as an exterior paint and which contains hollow glass beads in an amount of 2 to 10 weight percent of the paint.

13. The paint defined in claim 12 which contains hollow glass beads in an amount of 3 to 8 weight percent of the paint.

14. The paint defined in claim 9 formulated as a roof paint and which contains hollow glass beads in an amount of 2 to 12 weight percent of the paint.

15. The paint defined in claim 14 which contains hollow glass beads in an amount of 2 to 8 weight percent of the paint.

16. A method of controlling temperature in an interior of a structure which comprises applying to both an interior and an exterior of an outside wall of said structure a brush-applicable paint comprising:
a substantially organic solvent free acrylate and water composition containing hollow glass beads in an amount of 2 to 20 weight percent of the paint and dispersed therein.

17. The method defined in claim 16 wherein said paint is applied in layers of a thickness of 0.15 to 0.6 mm.

18. An exterior wall of a building having interior and exterior surfaces thereof coated with 0.15 to 0.6 mm coatings of a brush-applicable paint comprising a substantially organic solvent free acrylate and water composition containing hollow glass beads in an amount of 2 to 20 weight percent of the paint and dispersed therein, the interior surface coating containing hollow glass beads in an amount of 11.5 to 17 weight percent of the paint and the exterior surface coating containing hollow glass beads in an amount of 3 to 8 weight percent of the paint, the hollow glass beads enclosing vacuums and having densities in the range of 0.2 to 0.3 g/cm³, and at least 50 percent by volume of the hollow glass beads having diameters between 20 and 70 μm.
